(19) United States
(12) Patent Application Publication
(10) Pub. No.: US 2026/0346716 A1
(43) Pub. Date: Nov. 5, 2026

(54) DISPLAY CONTROL METHOD AND DISPLAY CONTROL DEVICE

(71) Applicant: Nissan Motor Co., Ltd., Yokohama-shi, Kanagawa (JP)

(72) Inventors: Atsushi KAJI, Kanagawa (JP); Hiroshi WATANABE, Kanagawa (JP)

(21) Appl. No.: 19/101,910

(22) PCT Filed: Aug. 10, 2022
(86) PCT No.: PCT/JP2022/030628

§ 371 Date: Feb. 7, 2025

(51) Int. Cl. B60K 35/233; B60K 35/90

(52) U.S. Cl. CPC B60K 35/233; B60K 35/90

(57) ABSTRACT

A display control method controls a display control device including a display, a detector and a controller. The controller acquires a viewpoint displacement information indicating a displacement of a viewpoint position of an occupant boarding a vehicle in a stationary system, sets a display position of a virtual image in the display as a set position when the viewpoint position is at a reference position fixed in the stationary system, and extracts a component having only a frequency equal to or lower than a predetermined frequency from one or more components constituting the displacement. The controller corrects the display position based on the extracted component, and does not correct the display position and maintains the set position, based on a component having a frequency higher than the predetermined frequency. The display position does not include a correction based on the component having a frequency higher than the predetermined frequency.

### CROSS-REFERENCE TO RELATED APPLICATIONS

This application is a U.S. national stage application of International Application No. PCT/JP2022/030628, filed on Aug. 10, 2022.

### BACKGROUND

### Technical Field

The present invention relates to a display control method and a display control device.

### Background Information

Japanese Patent Laid-Open Publication No. 2018-103888 (Patent Literature 1) discloses a head-up display device that displays a virtual image so as to be superimposed on an object in the scenery outside the vehicle. According to the head-up display device, the position of the viewer's viewpoint in the vertical direction is acquired, and the virtual image is corrected according to the amount of deviation of the acquired position of the viewer's viewpoint from a reference position in the vertical direction, so as to prevent the virtual image from shifting from the target object, and a display image is generated based on the corrected virtual image.

### SUMMARY

According to the technology described in Patent Literature 1, in case that the position of the occupant's viewpoint changes rapidly, there is a problem that the corrected virtual image may cause an uncomfortable feeling due to a time delay when correcting the virtual image.

The present invention has been made in view of the above problems. An object of the present invention is to provide a display control method and a display control device that can suppress discomfort caused by a virtual image that is corrected and displayed so as to be superimposed on the foreground as seen by the occupant, even if the position of the occupant's viewpoint changes rapidly.

In order to solve the above-described problems, a display control method and a display control device, according to an aspect of the present invention, acquire a viewpoint displacement information indicating a displacement of a viewpoint position of an occupant boarding in a vehicle in a stationary system of the vehicle, extract, based on the viewpoint displacement information, at least one specific component that has only a frequency equal to or lower than a predetermined frequency from among at least one component that constitutes the displacement, and correct a display position of a virtual image displayed in a display area that transmits surroundings of the vehicle, based on the specific component.

According to the present invention, it is possible to suppress discomfort caused by a virtual image that is corrected and displayed so as to be superimposed on the foreground as seen by the occupant, even if the position of the occupant's viewpoint changes rapidly.

### BRIEF DESCRIPTION OF DRAWINGS

Referring now to the attached drawings which form a part of this original disclosure, illustrative embodiments are shown.

FIG. 1 is a block diagram illustrating the configuration of the display control device according to the embodiment of the present invention.

FIG. 2 is a flowchart illustrating the configuration of the display control device according to the embodiment of the present invention.

FIG. 3 is a diagram illustrating an example of the relationship between the amplitude of the specific component and the correction amount of the display position.

FIG. 4 is a diagram illustrating an example of a shift in the position of the virtual image due to a shift in the occupant's viewpoint position.

### DETAILED DESCRIPTION OF EMBODIMENTS

Hereinafter, embodiments of the present invention will be described with reference to the drawings. In the description of the drawings, the same items are designated by the same reference numerals and duplicate description will be omitted.

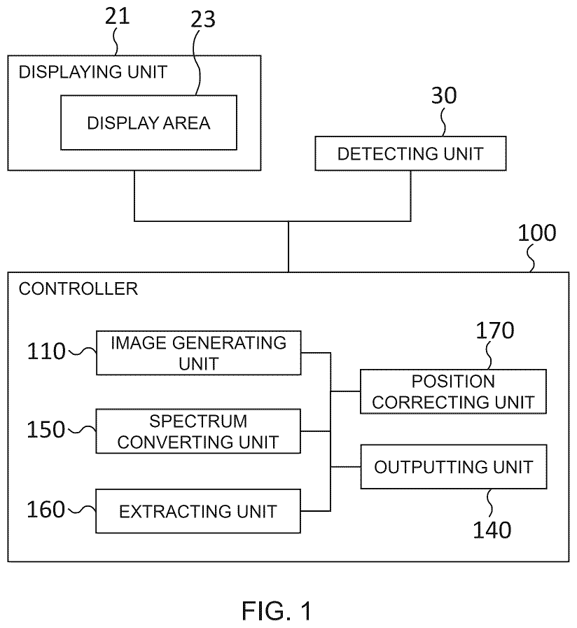

An example of the configuration of the display control device according to the present embodiment will be described with reference to FIG. 1. The display control device is mounted on a vehicle, for example. As shown in FIG. 1, the display control device includes a displaying unit 21, a detecting unit 30, and a controller 100.

The displaying unit 21 is connected to the controller 100 and has a display area 23 that transmits surroundings of the vehicle so that the surroundings of the vehicle can be viewed from the driver's seat of the vehicle or other seats of the vehicle. In the display area 23, an AR (Augmented Reality) guide (image) generated by the controller 100 is displayed. Therefore, in the display area 23, the AR guide is displayed superimposed on the scenery around the vehicle.

The AR guide presented by the displaying unit 21 expresses, for example, a guide route to the vehicle's destination, a road map, the vehicle's current position, and POIs that are places of interest to the user scattered between the vehicle and the destination.

For example, the displaying unit 21 is a head-up display device. The display area 23 may be a predetermined area in the windshield WS (windshield) of the vehicle, and the AR guide may be projected onto the display area 23 from a projector (not shown) to present the AR guide to the user. As a result, the user visually recognizes the AR guide superimposed on the scenery around the vehicle seen through the windshield WS.

The detecting unit 30 acquires a viewpoint displacement information indicating a displacement of the viewpoint position of an occupant boarding in the vehicle in the stationary system of the vehicle. More specifically, the detecting unit 30 acquires an image of the occupant's head using a camera installed inside the vehicle (in-vehicle camera), and acquires the position of the occupant's viewpoint (eye position) and the direction of the line of sight (the direction the eyes are facing), based on the image. The detecting unit 30 may also be used as a driver monitoring system (DMS) or an occupant monitoring system (OMS).

The driver monitoring system is a system that uses an in-vehicle camera to monitor the driving conditions of occupants, with the aim of preventing dangerous driving and accidents. For example, the driver monitoring system performs facial recognition, dangerous driving detection, distracted driving detection, drowsy driving detection, and determination of age, gender, and facial expression. Similarly, the occupant monitoring system is a system that monitors the condition of the occupant using an in-vehicle camera.

The viewpoint displacement information indicating a displacement of the viewpoint position of an occupant boarding in the vehicle indicates the amount of displacement of the viewpoint position of the occupant from a fixed position (reference position) in the stationary system of the vehicle. The viewpoint displacement information includes information on the displacement of the viewpoint position along the longitudinal direction of the vehicle (the traveling direction when the vehicle travels straight), information on the displacement of the viewpoint position along the vertical direction of the vehicle (the height direction of the vehicle), and information on the displacement of the viewpoint position along the lateral direction perpendicular to the longitudinal direction and the vertical direction.

The controller 100 is a general-purpose computer that includes a CPU (Central Processing Unit), a memory, a storage device, an input/output unit, and the like. The controller 100 may be connected to a navigation device (not shown). For example, the navigation device performs route guidance for the vehicle.

A computer program for functioning as the display control device is installed in the controller 100. By executing the computer program, the controller 100 functions as a plurality of information processing circuits (110, 150, 160, 170, 140) included in the display control device. Note that the computer program may be stored in a computer-readable and writable recording medium.

This embodiment shows an example in which a plurality of information processing circuits (110, 150, 160, 170, 140) are realized by software. However, it is also possible to configure the information processing circuits (110, 150, 160, 170, 140) by preparing dedicated hardware for executing each information processing described below. Further, the plurality of information processing circuits (110, 150, 160, 170, 140) may be configured with separate hardware. Furthermore, the information processing circuits (110, 150, 160, 170, 140) may also be used as a navigation device or a control unit used to control the vehicle.

As shown in FIG. 1, the controller 100 includes a plurality of information processing circuits (110, 150, 160, 170, 140) including an image generating unit 110, a spectrum converting unit 150, an extracting unit 160, a position correcting unit 170, an outputting unit 140.

For example, the image generating unit 110 generates an AR guide (virtual image) that overlaps the route the vehicle is scheduled to travel, which is visible to the occupant in the display area 23 when viewed from the driver's seat. Note that the image generating unit 110 sets the display position of the AR guide assuming that the viewpoint of the occupant seated in the driver's seat is at a fixed position (reference position) in the stationary system of the vehicle. The display position is corrected by a position correcting unit 170, which will be described later, based on the viewpoint displacement information.

The spectrum converting unit 150 decomposes the displacement of the occupant's viewpoint position into at least one or more components based on the viewpoint displacement information. For example, the spectrum converting unit 150 performs Fourier transform on the displacement of the occupant's viewpoint position and decomposes the displacement into components for each frequency. In addition, the spectrum converting unit 150 may calculate the phase of each component obtained by decomposition.

Based on the viewpoint displacement information, the extracting unit 160 extracts at least one specific component having only a frequency equal to or lower than a predetermined frequency from among at least one or more components constituting the displacement of the occupant's viewpoint position. For example, the extracting unit 160 may extract at least one or more specific components having only a frequency equal to or lower than the predetermined frequency from among the components for each frequency obtained by the spectrum converting unit 150. Alternatively, the extracting unit 160 may use a low-pass filter to extract the specific component having only a frequency equal to or lower than the predetermined frequency from the displacement of the occupant's viewpoint position.

The specific component may be extracted by the extracting unit 160 in each of the longitudinal, vertical, and lateral directions of the vehicle. That is, the extracting unit 160 may extract the specific component with respect to the displacement of the viewpoint position along the longitudinal direction of the vehicle. The extracting unit 160 may extract the specific component with respect to the displacement of the viewpoint position along the vertical direction of the vehicle. The extracting unit 160 may extract the specific component with respect to the displacement of the viewpoint position along the lateral direction of the vehicle.

The position correcting unit 170 corrects the display position of the virtual image displayed in the display area 23 based on the specific component extracted by the extracting unit 160. The specific component has a frequency equal to or lower than the predetermined frequency, and does not have a frequency greater than the predetermined frequency. Therefore, the display position correction by the position correcting unit 170 is performed based on only components having frequencies equal to or lower than the predetermined frequency.

Therefore, if the position of the occupant's viewpoint changes at a frequency higher than the predetermined frequency due to vibrations of the vehicle or the like, the position correcting unit 170 does not correct the display position. On the other hand, if the position of the occupant's viewpoint changes at a frequency equal to or lower than the predetermined frequency due to fatigue of the occupant or a change in posture during driving, the display position is corrected by the position correcting unit 170. As a result, the discomfort caused by the corrected virtual image caused by a time delay during control to correct the display position is reduced.

Further, the position correcting unit 170 may set the correction amount to be larger as the amplitude of the specific component is larger, and may change the display position by the correction amount. This prevents the position of the AR guide, which is displayed superimposed on the scenery around the vehicle, from being displayed at a position that deviates greatly from the scenery around the vehicle.

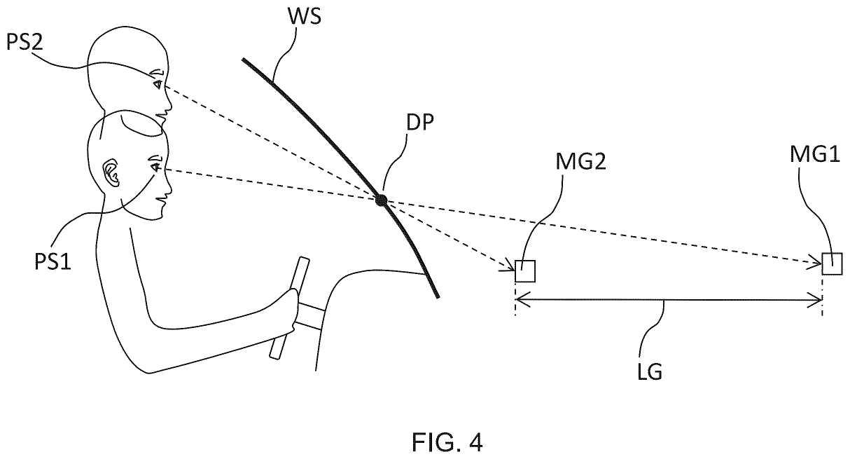

The point where the display position of the AR guide changes due to the displacement of the occupant's viewpoint position will be explained with reference to FIG. 4. FIG. 4 is a diagram illustrating an example of a shift in the position of the virtual image due to a shift in the occupant's viewpoint position. Light projected from a projector (not shown) is reflected by, for example, a reflection point DP on the windshield WS and reaches the occupant's viewpoint, so that the occupant visually recognizes the AR guide.

When the occupant's viewpoint is at position PS1, the occupant recognizes that the virtual image corresponding to the AR guide is at position MG1. Here, if the occupant's viewpoint changes to position PS2 in a situation where the reflection point DP does not change, the occupant will see that the virtual image corresponding to the AR guide is at position MG2. That is, when the occupant's viewpoint changes from position PS1 to position PS2, the position of the virtual image corresponding to the AR guide changes from position MG1 to position MG2.

Since the positions MG1 and MG2 are shifted by a distance LG along the longitudinal direction of the vehicle, depending on the length of the distance LG, the virtual image displayed superimposed on the scenery around the vehicle may give an unpleasant feeling. Therefore, it is necessary to change the reflection point DP to prevent the position of the virtual image corresponding to the AR guide from changing from position MG1 to position MG2.

However, changes in the occupant's viewpoint position can include both rapid changes caused by vibrations of the vehicle and slow changes caused by fatigue of the occupant or changes in posture during driving. Therefore, if the display position is corrected based on all frequency components included in changes in the occupant's viewpoint position, the display position correction will be delayed due to the time delay when correcting the virtual image. In this case, the corrected virtual image gives an unpleasant feeling. In order to suppress the unpleasant feeling that may accompany such correction, the position correcting unit 170 corrects the display position based on components that only have frequencies equal to or lower than the predetermined frequency.

Note that the position correcting unit 170 may correct the display position when the amplitude of the specific component is larger than a predetermined threshold. As a result, if the display position of the AR guide does not deviate significantly from the scenery around the vehicle, the display position is not corrected, and the processing load associated with the display position correction is reduced.

In addition, the position correcting unit 170 may set the first threshold as the predetermined threshold value when the specific component is a component along the vertical direction of the vehicle. Then, the position correcting unit 170 may set a second threshold larger than the first threshold as the predetermined threshold when the specific component is a component along the lateral direction of the vehicle. The reason for this can be explained as follows. The positional displacement of the virtual image caused by the component along the vertical direction due to a change in the distance between the virtual image and the vehicle has the largest component. This is because the positional displacement of the virtual image caused by the component along the vertical direction tends to give a sense of discomfort to the occupant, and there is a high need for correction.

Moreover, the position correcting unit 170 may set a third threshold larger than the second threshold as the predetermined threshold when the specific component is a component along the longitudinal direction. The reason for this can be explained as follows. The positional displacement of the virtual image caused by the component along the longitudinal direction due to a change in the distance between the virtual image and the vehicle has the smallest component. This is because the positional displacement of the virtual image caused by the component along the longitudinal direction does not easily give a sense of discomfort to the occupant, and there is little need for correction.

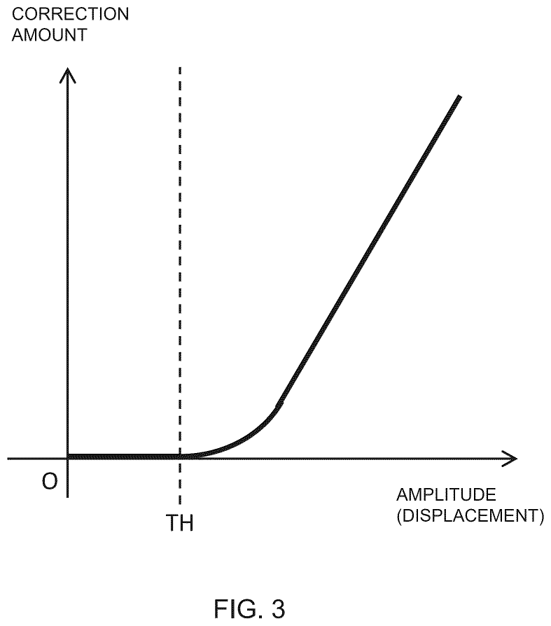

FIG. 3 shows how the correction amount is set by the position correcting unit 170. FIG. 3 is a diagram illustrating an example of the relationship between the amplitude of the specific component and the correction amount of the display position. For example, as shown in FIG. 3, the position correcting unit 170 may correct the display position when the amplitude (displacement) of the specific component is larger than a predetermined threshold TH. The position correcting unit 170 may set the display position correction amount to be larger as the amplitude of the specific component is larger. This makes it possible to suppress the sense of discomfort that may occur when correcting the display position.

Furthermore, the position correcting unit 170 may continuously and smoothly increase the correction amount of the display position in response to an increase in the amplitude of the specific component. Here, “smoothly increase” means that when the correction amount of the display position is viewed as a function of the amplitude of the specific component, the differentiation of the function with respect to the amplitude is continuous. Thereby, it is possible to suppress the sense of discomfort that may occur due to correction of the display position.

The outputting unit 140 outputs the AR guide generated by the image generating unit 110. The output AR guide is displayed in the display area 23 at the display position corrected by the position correcting unit 170.

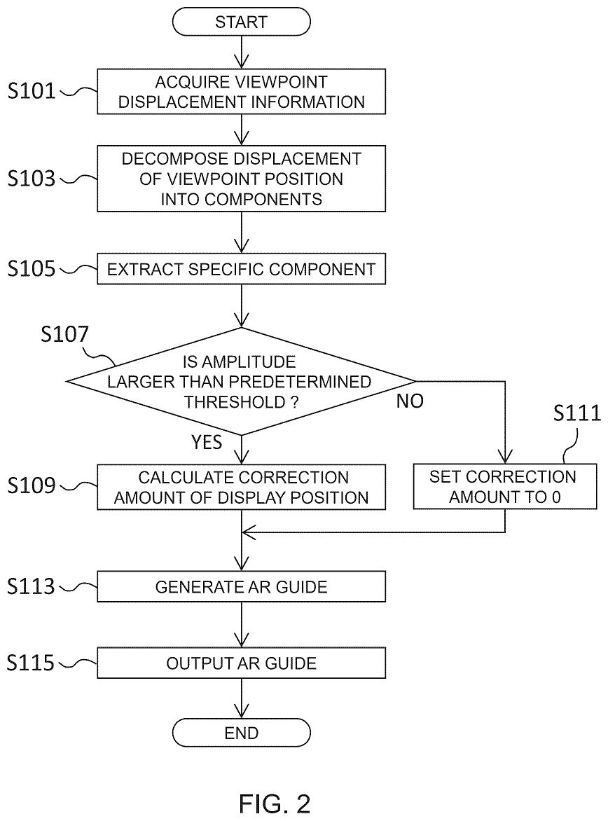

Next, the processing procedure of the display control device according to the present embodiment will be explained with reference to the flowchart of FIG. 2. FIG. 2 is a flowchart illustrating the configuration of the display control device according to the embodiment of the present invention.

In step S101, the detecting unit 30 acquires viewpoint displacement information indicating a displacement of the viewpoint position of an occupant boarding in the vehicle in the stationary system of the vehicle.

In step S103, the spectrum converting unit 150 performs Fourier transform on the displacement of the occupant's viewpoint position and decomposes the displacement into components for each frequency.

In step S105, the extracting unit 160 extracts at least one specific component having only frequencies below a predetermined frequency from among the frequency-based components obtained by the spectrum converting unit 150.

In step S107, the position correcting unit 170 determines whether the amplitude of the specific component is larger than a predetermined threshold.

If it is determined that the amplitude of the specific component is larger than the predetermined threshold (YES in step S107), in step S109, the position correcting unit 170 calculates the correction amount of the display position. On the other hand, if it is determined that the amplitude of the specific component is equal to or lower than the predetermined threshold (NO in step S107), the position correcting unit 170 sets the correction amount of the display position to 0 in step S111.

In step S113, the image generating unit 110 generates an AR guide (image). After that, the position correcting unit 170 corrects the display position of the virtual image displayed in the display area.

In step S115, the outputting unit 140 outputs the AR guide whose display position has been corrected. The output AR guide is presented to the user via the display area 23. Thereafter, the processing of the display control device ends.

As explained in detail above, a display control method and a display control device, according to the present embodiment, acquire a viewpoint displacement information indicating a displacement of a viewpoint position of an occupant boarding in a vehicle in a stationary system of the vehicle, extract, based on the viewpoint displacement information, at least one specific component that has only a frequency equal to or lower than a predetermined frequency from among at least one component that constitutes the displacement, and correct a display position of a virtual image displayed in a display area that transmits surroundings of the vehicle, based on the specific component.

As a result, it is possible to suppress discomfort caused by a virtual image that is corrected and displayed so as to be superimposed on the foreground as seen by the occupant, even if the position of the occupant's viewpoint changes rapidly.

In particular, when the position of the occupant's viewpoint changes at a frequency higher than the predetermined frequency due to vibrations of the vehicle or the like, the display position is not corrected. On the other hand, if the position of the occupant's viewpoint changes at a frequency equal to or lower than the predetermined frequency due to fatigue of the occupant or a change in posture during driving, the display position will be corrected. As a result, the discomfort caused by the corrected virtual image caused by a time delay during control to correct the display position is reduced.

Further, the display control method and the display control device, according to the present embodiment, may correct the display position when an amplitude of the specific component is larger than a predetermined threshold. As a result, if the display position of the AR guide does not deviate significantly from the scenery around the vehicle, the display position is not corrected, and the processing load associated with the display position correction is reduced.

Furthermore, the display control method and the display control device, according to the present embodiment, may set a first threshold as the predetermined threshold when the specific component is a component along a vertical direction of the vehicle, and set a second threshold larger than the first threshold as the predetermined threshold when the specific component is along a lateral direction perpendicular to a longitudinal direction of the vehicle and the vertical direction. The positional displacement of the virtual image caused by the component along the vertical direction due to a change in the distance between the virtual image and the vehicle has the largest component. The positional displacement of the virtual image caused by the component along the vertical direction tends to give a sense of discomfort to the occupant, and there is a high need for correction. Therefore, correction is performed only when the need for correction of the display position is high, and the processing load is reduced.

Further, the display control method and the display control device, according to the present embodiment, may set a third threshold larger than the second threshold as the predetermined threshold when the specific component is along the longitudinal direction. The positional displacement of the virtual image caused by the component along the longitudinal direction due to a change in the distance between the virtual image and the vehicle has the smallest component. The positional displacement of the virtual image caused by the component along the longitudinal direction does not easily give a sense of discomfort to the occupant, and there is little need for correction. Therefore, correction is performed only when the need for correction of the display position is high, and the processing load is reduced.

Furthermore, the display control method and the display control device, according to the present embodiment, may set a larger correction amount as an amplitude of the specific component becomes larger, and changes the display position by an amount of the correction amount. Thereby, it is possible to suppress the sense of discomfort that may occur due to the correction of the display position.

Respective functions described in the above embodiment may be implemented by one or plural processing circuits. The processing circuits include programmed processors, electrical circuits, etc., as well as devices such as application specific integrated circuits (ASIC) and circuit components arranged to perform the described functions, etc.

Although the contents of the present invention have been described above with reference to the embodiment, the present invention is not limited to these descriptions, and it will be apparent to those skilled in the art that various modifications and improvements can be made. It should not be construed that the present invention is limited to the descriptions and the drawings that constitute a part of the present disclosure. On the basis of the present disclosure, various alternative embodiments, practical examples, and operating techniques will be apparent to those skilled in the art.

It is needless to mention that the present invention also includes various embodiments that are not described herein. Therefore, the technical scope of the present invention is to be defined only by the invention specifying matters according to the scope of claims appropriately obtained from the above descriptions.

### REFERENCE SIGNS LIST

21 displaying unit
23 display area
30 detecting unit
100 controller
110 image generating unit
140 outputting unit
150 spectrum converting unit
160 extracting unit
170 position correcting unit

1. A display control method for controlling a device comprising a display, a detector, and a controller, wherein
the display has a display area that transmits surroundings of a vehicle,
the detector acquires a viewpoint displacement information indicating a displacement of a viewpoint position of an occupant boarding in the vehicle in a stationary system of the vehicle,
the controller
sets, as a set position, a display position of a virtual image displayed in the display area when the viewpoint position is at a reference position fixed in the stationary system,
extracts, based on the viewpoint displacement information, at least one specific component that has only a frequency equal to or lower than a predetermined frequency from among at least one component that constitutes the displacement,
corrects the display position of the virtual image displayed in the display area based on the specific component, and
does not correct the display position and maintains the set position, based on the component that has a frequency higher than the predetermined frequency, and
the display position does not include correction based on the component that has a frequency higher than the predetermined frequency.

2. The display control method according to claim 1, wherein
the controller corrects the display position when an amplitude of the specific component is larger than a predetermined threshold.

3. The display control method according to claim 2, wherein
the controller
sets a first threshold as the predetermined threshold when the specific component is a component along a vertical direction of the vehicle, and
sets a second threshold larger than the first threshold as the predetermined threshold when the specific component is along a lateral direction perpendicular to a longitudinal direction of the vehicle and the vertical direction.

4. The display control method according to claim 3, wherein
the controller sets a third threshold larger than the second threshold as the predetermined threshold when the specific component is along the longitudinal direction.

5. The display control method according to claim 1, wherein
the controller sets a larger correction amount as an amplitude of the specific component becomes larger, and changes the display position from the set position by an amount of the correction amount.

6. A display control device comprising a display, a detector, and a controller, wherein
the display has a display area that transmits surroundings of a vehicle,
the detector acquires a viewpoint displacement information indicating a displacement of a viewpoint position of an occupant boarding in the vehicle in a stationary system of the vehicle,
the controller
sets, as a set position, a display position of a virtual image displayed in the display area when the viewpoint position is at a reference position fixed in the stationary system,
extracts, based on the viewpoint displacement information, at least one specific component that has only a frequency equal to or lower than a predetermined frequency from among at least one component that constitutes the displacement,
corrects the display position of the virtual image displayed in the display area based on the specific component, and
does not correct the display position and maintains the set position, based on the component that has a frequency higher than the predetermined frequency, and
the display position does not include correction based on the component that has a frequency higher than the predetermined frequency.
